(19) United States
(12) Patent Application Publication
(10) Pub. No.: US 2020/0005365 A1
(43) Pub. Date: Jan. 2, 2020

(54) System and Method for Creating Transparently Motivated Transactions

(71) Applicant: James Winnard, Seattle, WA (US)

(72) Inventor: James Winnard, Seattle, WA (US)

(21) Appl. No.: 16/457,659

(22) Filed: Jun. 28, 2019

Related U.S. Application Data
(60) Provisional application No. 62/691,596, filed on Jun. 28, 2018.

(51) Int. Cl. G06Q 30/02; G06F 16/9535; G06Q 30/06

(52) U.S. Cl. CPC G06Q 30/0282; G06Q 30/0261; G06Q 30/0609; G06F 16/9535

(57) ABSTRACT

A method for machine to machine interaction between a buyer having a portable digital device and a seller having a digital device to effect selective buyer control of conditions or criteria under which the seller is identified from among a group of sellers and ‘returned’ to the buyer in a buyer search such that then and only then does the seller become ‘visible’ to the buyer.

The portable device stores in a first machine readable memory one or more conditions under which the buyer is willing to do business with the group of sellers of a selectable range of commodities and or services. The seller device stores in a second machine readable memory one or more seller-certified behaviors through which the seller promises to do business.

A processor assembles, from the second machine readable memory, a continually updated listing of sellers meeting, with their latest certified behaviors, the latest stored buyer conditions and ranges.

### CROSS REFERENCE TO RELATED APPLICATIONS

This application claims priority to the U.S. Provisional Patent Application 62/691,596 filed Jun. 28, 2018 which is hereby incorporated by this reference as if fully set forth herein.

### TECHNICAL FIELD

This disclosure relates to automated, real time, instantaneous and continuously monitored processes; more particularly, it relates to automated, real time, instantaneous and continuously monitored transactional systems for customers and business owners; more particularly, it relates to systems and methods for creating transparently motivated transactions.

### BACKGROUND

Every successful business owner understands that customer trust, loyalty and respect are earned, not guaranteed. A customer wants to support businesses that reflect and embody her personal ideals, and that provide affordable products or services in an environmentally and socially sustainable and profitable manner.

However, in modern commerce where the customer may not know the business owner personally, it is increasingly difficult to discern where the true commitments and ideals of the business owner lie. Often, the vagaries of corporate ownership and advertising and promotion only serve as a veil to further obscure such business owner commitments and ideals.

Then also, a business always faces the challenges of maintaining and increasing its customer base, sometimes at considerable cost in marketing, advertising and promotion. In many cases, businesses spend money for such customer acquisition and maintenance, with no real guarantee or quantification of success. After all, advertising costs are paid in advance and no one guarantees any result from the expense.

What is needed is a transactional system that provides for business owners to declare their commitments and ideals transparently to the public and that allows a customer to specify that only certain businesses matching her criteria for environmentally and socially sustainable products and services be displayed for her purchasing requirements. In turn, the system levies a charge on the business for the transaction, but only when completed.

Identify. Connect. Reward.

### DISCLOSURE

A transactional system that provides for business owners to declare their commitments and ideals transparently to the public and that allows a customer to specify that only certain businesses matching her criteria for environmentally and socially sustainable products and services be displayed for her purchasing requirements is disclosed. The system provides for an automated charge to be levied on the business for the transaction upon meeting circumstances selected in advance, but only when the transaction is completed. The disclosed system and its methods provide automated, real time, instantaneous and continuously monitored processes and automated, real time, instantaneous and continuously monitored transactional systems for customers and business owners.

Business owners are invited to register and declare their ideals and commitments openly and transparently in a voluntarily selectable variety of categories and each registered customer is invited to specify criteria in voluntarily selectable categories which are instantaneously and in real time continually monitored and matched with registered business listed category response data to effect a displayed listing of businesses matching her criteria for ideals. This might be termed “intelligent spending.”

In some system embodiments, the system is also optionally customer location based, a feature which can be selectably turned on or off as desired by the customer. The disclosed system is advantageously provided as a mobile application platform for connecting consumers with like-minded providers of goods and services. Business are thus encouraged and given an opportunity to rapidly and transparently earn the trust, respect and loyalty of like-minded customers.

This may have particular applications with respect to customer and business progressive ideals, and is expected to serve the notion that business can be profitable and progressive as well as sustainable.

The system supports the maxim that “It need not cost more to do the right thing” by maximizing efficiency in monitoring and matching unique preferences of individual community members with merchants, optionally in their area, whose business practices align closely with individual users' standards, and all of that in real time.

### EXAMPLE

In some circumstances, businesses paying a fair wage or protecting the environment, or offering worker benefits or the like standards may have higher costs of doing business and may not be cost competitive with other businesses who do not provide such standards, or fewer of them.

The system addresses these costs and increases profit and competitiveness by reducing cost of customer acquisition, increasing number of units sold, and even allowing a lower per unit sales cost and increasing bottom line/profits. It may also increase exposure to previously unreached customer bases. It also increases business visibility and word of mouth within a highly motivated, ideologically driven community of users seeking to end their unintentional support for regressive business practices.

In general, system community users create unique, personal profiles for different classes of products or services they frequently purchase. Each user creates her own unique profile that, beyond geographic proximity, includes desired sought-out behaviors on the part of a merchant. The user defines what a business must offer, beyond product and location, before that business even becomes “visible” to that user. Of course, in the system, merchants who do not meet the user profile do not appear to the user at all.

### EXAMPLE

Joe may prefer, when looking at restaurants, that it be no more than eight miles from present location, a confirmation that workers earn >20% above minimum wage, that there are grass fed beef options, vegetarian options, and or that certain employee benefits are scrupulously observed. When Joe looks at the app on his mobile device, looking at available restaurants, he only sees those that meet the selected criteria. In general, businesses are invited to register with the system. Also users are encouraged to identify a business they would like to invite to join the buying community and, if the business is not yet participating, an invitation is sent to the business by the system. The benefits of access to this community of users are clearly articulated within the invitation. Merchants establish an account and each develop their own searchable public profile, including a pledge to certain sustainable or socially equitable practices and commitments. The business profile is advantageous created through answering a series of questions related to how their business practices align to specified buying community member preferences. The more data points provided in the business profile, the stronger the potential association/match with user searches, and the more the business become “visible” to the greater customer base.

Each community user selectably determines when her search, by product or service classification, is active. Users easily and dynamically change their own criteria for what merchants are returned in a search and the extent to which such merchants become “visible” to the user. Correspondingly, merchants are encouraged to update or expand their respective commitment profiles regularly.

Transparent businesses are rewarded by their respectively similarly aligned user communities. On the other hand businesses whose practices fail to effectively align with the behavioral preferences of the community, or who are simply not registered at all, are not returned in a particular user's search. The are “not visible”. The risk of unintentionally funding a business whose business practices are diametrically opposed to the values of the user is significantly reduced.

The system also provides an optional platform for definition of the terms under which a merchant can earn higher privilege with a user and the ability to communicate directly to such a user and or to send the user special offers. These terms of dynamic, real time merchant-to-user communication are entirely user defined and continuously monitored for change by the system.

For the case that a merchant is given one of the higher privileges, i.e. permission to send offers via message or other media to that customer, the system not only dynamically and continuously monitors the permission in real time, but assigns an identifier to the permitted message and continually monitors for whether or not that offer is actually viewed by the customer to whom the offer was sent, and enters a billing event to the account of the merchant for receipt of the offer. In heightened permission, a merchant can publish a discount to the user or most anything else consistent with user permissions and profile values.

### EXAMPLE

Jane is presented with a list of charitable donations among which she can select. Once the merchant builds their business profile and agrees to make a donation to the user's selected charity after purchase, privilege is escalated and direct SMS text communication (or the like) with the community member is allowed.

Advantageously, the system optionally monitors a user's GPS signal. When the GPS signal indicates that the user has entered within a selectable and specified area of a merchant who has met the user's heightened permission criteria, a communication is automatically generated. Optionally, the communication is held until and unless the system also receives from the user's mobile device a signal that it is ‘on’ and the app is open and active for the user. Note this could be a merchant to customer communication or one from customer to merchant.

There is continual monitoring of customer criteria being changed, and a continuous monitoring of when customers or merchants have respective applications open. The system generates a response (communication message) whenever a customer or merchant updates a criteria or enters a new one, and instantaneously sends the communication when the system is notified through the continuous monitoring that the intended recipient of the message is running the respective application. Thus the email or SMS or the like is sent only if or when the intended recipient is running the application, is online and ready to receive.

This, like many other application processes in the system, is a continually monitored automated process, like stock exchange monitoring that alerts a user the instant their computer (or cell phone, etc.) is turned on.

Changing conditions of permission in a population of permissions (like monitoring chemicals and states in a reaction chamber) and other states of the system (whether on user side or merchant side) are monitored by the system continuously in real time, and any particular list of selected “visible” merchants for a given user query is automatically and instantly changed in real time in accordance with this monitoring. Similarly there is real time monitoring for state change in a device (device on/off, gps on/off, etc) and then checking current state of permissions and instructions and automatic sending of messages in accordance.

Thus a user creates a flexible, easily changed, dynamic profile of required business (seller) behaviors before a seller ever becomes “visible” in search or query results. Businesses are provided with dynamic continually updated data on buyers preferences/desired business behaviors and commitments among local user (buyer) communities, the better for businesses to change or announce behaviors and commitments consistent with the updated data. They are provided with a portal to the system there they each build an updatable profile, against which a user (buyer) searches. Businesses are given a mechanism to create and send incentive offers to unique users based on user profiles. Desirably, sellers only pay through the system when such a customer incentive offer event is noted by the system, such as the offer is opened by the customer (or otherwise noted in the system as received by the user to which it is addressed), or the offer is redeemed by the customer and a purchase transaction or coded entry is noted by the system.

The system comprises a mobile app for end users (buyers), and a web-based portal for merchants (sellers). The app provides a means through which the buyer creates an continuously updatable individual profile of behaviors (social, economic, environmental) that the buyer would like to see in a business before that seller becomes can even become “visible” to that buyer, such as by being returned in a search.

A mechanism is provided for proof to the merchant that an incentive offer sent via their portal has been not only opened, but that the user has responded and paid the merchant. This is accomplished with the user entering a three digit number provided by the merchant to the user at time of payment.

### EXAMPLE

The system charges 25 [symbol] when the user enters a 3 digit number provided by merchant. Alternatively, merchants are enabled allowed to send focused incentives to users. Merchant pays 0.10 for each incentive advertisement/communication sent only to interested customers who have opted to be sent one.

Businesses (sellers) are provided with a portal through which they are provided real (RT) data on the top/most important business behaviors (social, economic, environmental) local buyers in their area (selectable) want to see in a business. The seller then builds a profile based on which of these behaviors (social, economic, environmental) they have adopted within their business.

Buyers initiate a machine to machine search for businesses within a given geographic distance offering a product or service they want. For the seller, a mechanism is offered for direct, automatic and instantaneous communication of incentive offers to a buyer when the buyer's priorities (and optional other buyer previously stated conditions) are matched. Buyers thus control the conditions under which sellers are allowed to create and send incentive offers. Identity of sellers who best match a buyer's profile of desired business behaviors are desirably returned to the buyer in response to search or query at no charge to the buyer,

### DETAILED DESCRIPTION

The disclosed system provides real time (RT) machine to machine interaction between buyers and sellers to programmatically effect dynamic, selective buyer control of the conditions or criteria (such as a RT buyer selectable profile of seller certified behaviors—social, economic, environmental) under which

a seller is ‘returned’ to the buyer in a search or query by the buyer (i.e. becomes ‘visible’ to the buyer;

a seller is allowed, in addition, to communicate directly with the buyer and or to create and send incentive offers directly to the buyer;

a buyer's search or query is active and or what the buyer search is active for (particular goods or services).

In this disclosure, the term real time or RT connotes continuous machine monitoring for the various changes discussed herein, and or appropriate machine generation of messages and or updates to query returns and or instantaneous transmission of such messages and or updates to intended recipients, desirably only when the recipient devise is ‘on’ and the respective app is open and active.

The disclosed system and methods are necessarily rooted in computer technology to overcome a problem specifically arising in machine to machine monitored and controlled buy sell transactions.

Advantageously there is RT machine to machine continuous monitoring of when buyers or sellers have their respective programmatic machines running, online and ready to receive (where the respective program itself automatically generates ,or has previously generated, an instantaneous response or communication message, which is then desirably sent to the respective recipient machine only when it is on and the respective app or site is open and active).

Advantageously there is RT machine to machine continuous monitoring of when buyer or seller machines have other ‘state changes’ as well (GPS on/off, Buyer change of criteria, Seller certification of changed behaviors, and the like).

Advantageously there is RT machine to machine continuous monitoring stored memory containing changing buyer conditions or criteria in, or from amongst, a population of such conditions, and programmatically providing to seller machines any such updated list of such buyer preferred seller behaviors so that sellers are incentivized to make selected seller changes to their particular certified behavior list in accordance with the monitoring.

Advantageously there is also a continuously machine monitored, dynamic, buyer-defined RT platform of criteria under which a seller can earn ‘heightened privilege’ with the buyer and thereby permission to
track in RT a particular buyer device's GPS location signal; and or
communicate directly to the buyer device (such as sending a particular offer or incentive directly to the buyer device in RT);
all with selectable programmatic machine monitoring of the buyer's stored platform data for changes and automatically generating a communication to the buyer device.

Advantageously there is RT machine to machine continuous monitoring of a particular seller machine incentive offer to a particular buyer device, including but not limited to when that offer has been not only received (opened) by the respective device, but also when that buyer device has responded and the seller's account has been credited with the sale (option for seller to be debited by the system only when that particular buyer device effects a purchase from that seller).

To which ends at least one method is provided for machine to machine interaction between a buyer and buyer portable digital device (such as but not limited to PDA, cell phone, or pad-type device now known or later developed) and a seller and seller digital device (such as but not limited to a computer or the like device for storage, calculation and sending and receiving data over a distributed network) to programmatically effect dynamic, selectable and selective buyer control of conditions or criteria under which the seller is identified from among a group or population of sellers and ‘returned’ to the buyer device from a buyer search or query for sellers of particular goods and or services such that then and only then does that seller and her device or store become ‘visible’ to the buyer (all other non-qualifying sellers remaining ‘in-visible’ to the buyer.

To effect this method, one or more conditions under which the buyer is willing to do business with a seller or sellers from the group of sellers of a selectable range of commodities and or services (and optionally from a selectable geographic locality or range or radius of localities) are transmitted over a distributed network from the buyer portable device and stored in a first machine readable memory.

Further, one or more seller-certified behaviors through which the seller declares or announces openly that she does business or promises to do business are transmitted over a distributed network from the seller digital device and stored in a second machine readable memory. Seller-certified behaviors include, but are not limited to, paying a living wage to employees (or a minimum wage standard, federal, local or invented), providing employee benefits (such as health care, tuition assistance, job training or the like), applying and adhering to environmental and health and planetary sustainability standards (whether legislated, advised by watchdog organizations, or created), celebrating and welcoming diversity in customer and employee gender, gender identification, sexual orientation and preference, race, color and religious, ethnic and socio-economic status or background. Some or all of these seller behaviors (as well as other seller behaviors elsewhere defined or discussed, whether now know or later devised) become ‘certified’ (or the like open and validatable or verifiable means of making an open and public commitment to such behaviors as a matter of committed business practice including integration of such behaviors into the core and commerce of the business or the like integration), at least in a first instance, simply by declaration of the seller in transmitting a statement of such behavior or behaviors for storage in the second machine readable memory.

Further, at least a first hardware processor operatively associated with the first and or the second machine readable memories is used to execute processor instructions stored therein, and responsive to conditions and ranges stored in the first memory to assemble, from the second memory, a listing of sellers meeting, with their latest certified behaviors, the latest stored buyer conditions and ranges.

Desirably, the portable device continuously monitors, and instantaneously sends over a distributed network to the first memory, any and all changes by the buyer to the buyer conditions and or to the selectable range of goods and or services stored in the first memory. And the processor executes instructions to continuously monitor the first memory for particular buyer condition and range updates, and to recompile or reassemble the listing of sellers meeting (under the updated conditions and ranges) the latest stored buyer conditions and ranges, and to automatically transmit the updated listing of sellers to the portable device.

Desirably, seller digital device continuously monitors, and instantaneously sends over a distributed network to the second memory, any and all changes by the seller to the seller-certified behaviors stored in the second memory. And the processor executes instructions to continuously monitor the second memory for particular seller-certified behavior updates, and to recompile or reassemble the listing of sellers meeting (under the updated seller-certified behaviors) the latest stored buyer conditions and ranges, and to automatically transmit the updated listing of sellers to the portable device. Optionally, and for sellers previously reviewed by buyer in searches that may or may not still be active, a notice of an update to one or more of such searches is automatically sent to the portable device. In this manner, a buyer who has already searched for “a burger under $10 within 5 miles from a seller who meets criteria A, B and C”, but who is not actively pursuing that search at a given moment, will be selectably notified if the return on that search has changed in any respect. For instance, some formerly listed sellers may no longer meet the criteria for that search, while a new seller or more may now meet such criteria through changed and updated seller-certified behaviors.

The portable device is advantageously programmed to continuously send for storage to the first machine readable memory a state datum corresponding to whether the buyer search is active or not, and the processor is instructed to continuously monitor that datum as well, with further instructions to deactivate the search when the datum equals ‘not active’ (or the like) and to optionally cease continuous monitoring of the first and second memories except for that datum, and to activate and instantaneously update the search and listing for sellers meeting the search criteria when the datum equals ‘active’ (or the like).

In like manner, the portable device is advantageously programmed to continuously send for storage to the first machine readable memory a state datum corresponding to whether the buyer portable device is on or not and or the app on the device active or not. And in like manner set forth just above, the processor is instructed to continuously monitor that datum as well, with further instructions to stop, start or modify the buyer search. The processor is further advantageously instructed to hold all automatically generated listings, notices and any other type of messages intended for a particular buyer portable device until the stored state datum for that device registers that the device is both ‘on’ and the app ‘active’.

In manner like to the methodology disclosed above, one or more updatable conditions under which the buyer is willing to extend to a seller a ‘heightened privilege’ with that buyer is stored in the first machine readable memory from the portable device. Instructions for performing one or more of the programmatic behaviors disclosed immediately below are stored in the second machine readable memory from the seller digital device:

(1) The portable digital device desirably continuously calculates and sends device location data over the distributed network to the first memory, and the processor is instructed to continuously monitory that device's location data.

(2) The seller sends to the second memory one or more form messages intended for sending to a buyer portable device (special offers, coded discount ‘coupons’ or the like).

And upon meeting the conditions for ‘heightened privilege’ (accomplished as above by the processor instructed appropriately for continuous monitoring of memories for conditions precedent to such ‘heightened privilege’ being met by the seller) the processor executes stored instructions to send to the appropriate digital device the particular stored offer or incentive. In addition the device location data may also be transmitted to the seller under ‘heightened privilege’ and or retained in memory and used as one of the criteria for release and sending of one or more of the stored incentive offers. In like manner described above, the processor is instructed to cease execution of ‘heightened privilege’ status options when continuous monitoring by the processor indicates that ‘heightened privilege’ has been withdrawn or its conditions no longer met.

With regard to systems and components above referred to, but not otherwise specified or described in detail herein, no concerted attempt to repeat here what is generally known to the artisan has been made.

I claim:

1. A method for machine to machine interaction between a buyer having a portable digital device and a seller having a digital device to programmatically effect dynamic, selective buyer control of conditions or criteria under which the seller is identified from among a group of sellers and ‘returned’ to the buyer in a buyer search or query such that then and only then does the seller become ‘visible’ to the buyer, the method comprising the following steps:
storing from the portable device in a first machine readable memory one or more conditions under which the buyer is willing to do business with the group of sellers of a selectable range of commodities and or services;
storing from the seller digital device in a second machine readable memory one or more seller-certified behaviors through which the seller promises to do business;
using at least a first hardware processor operatively associated with the first and second machine readable memories to execute processor instructions stored therein, and responsive to conditions and ranges stored therein to assemble, from the second machine readable memory, a continually updated listing of sellers meeting, with their latest certified behaviors, the latest stored buyer conditions and ranges.

2. The method of claim 1, further including the steps of
the portable device instantaneously sending over a distributed network to the first machine readable memory buyer changes to the buyer conditions and or the selectable range of good and or services stored therein;
the processor further programed with stored instructions to continuously monitor for any such buyer changes and to update the listing of sellers meeting the updated stored buyer conditions and ranges and to transmit the updated listing to the portable device.

3. The method of claim 1, further including the steps of
the seller digital device instantaneously sending over a distributed network to the second machine readable memory seller changes to the seller-certified behaviors stored therein;
the processor further programed with stored instructions to continuously monitor for any such seller changes and to update the listing of sellers meeting the updated stored buyer conditions and ranges and to transmit the updated listing to the portable device.

4. The method of claim 2, further including the steps of
the portable device continuously sending for storage to the first machine readable memory a state datum corresponding to whether the buyer search is active or not;
the processor continuously monitoring that datum, to deactivate the search when the datum equals ‘not active’ and to cease continuous monitoring of the first and second memories except for that datum, and to activate and instantaneously update the search and listing for sellers meeting the search criteria when the datum equals ‘active’.

5. The method of claim 3, further including the steps of
the portable device continuously sending for storage to the first machine readable memory a state datum corresponding to whether the buyer search is active or not;
the processor continuously monitoring that datum, to deactivate the search when the datum equals ‘not active’ and to cease continuous monitoring of the first and second memories except for that datum, and to activate and instantaneously update the search and listing for sellers meeting the search criteria when the datum equals ‘active’.

6. The method of claim 3, further including the step of the processor continuously monitoring the second memory for seller updates of listed committed behavior and causing notice of any such update to be sent to buyer, for sellers previously reviewed by buyer.

7. The method of claim 1, further including the step of the portable digital device continuously calculating and sending device location data over the distributed network to the first memory.

8. A method for machine to machine interaction between a buyer having a portable digital device and a seller having a digital device, the method comprising the following steps:
storing from the portable device in a first machine readable memory one or more updatable conditions under which the buyer is willing to extend to a seller a ‘heightened privilege’ with the buyer;
storing from the seller digital device in a second machine readable memory instructions for performing one or more of the following programmatic behaviors:
tracking in RT a particular buyer's GPS location signal;
communicating directly to the buyer with a particular offer or incentive directly to the portable device;
using at least a first hardware processor operatively associated with the first and second machine readable memories to continuously monitor the state and extent of any such ‘heightened privilege’ and, when conditions for ‘heightened privilege’ are met, to execute one or more of the processor instructions stored in the second memory for ‘heightened privilege’ and to cease execution when continuous monitoring indicates that ‘heightened privilege’ has been withdrawn or its conditions no longer met.

9. The method of claim 8, further including the step of
automatically generating a communication to the buyer.
